(19) United States
(12) Patent Application Publication
(10) Pub. No.: US 2007/0211470 A1
(43) Pub. Date: Sep. 13, 2007

(54) Lamp house with heat sink

(76) Inventor: Hsien-Jung Huang, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/366,618

(22) Filed: Mar. 3, 2006

(51) Int. Cl. F21V 29/00

(52) U.S. Cl. 362/294

(57) ABSTRACT

A heat sink device for configuring a lamp house is disclosed. The heat sink device includes a heat sink and a lamp house. The lamp house is telescoped into the heat sink. The heat sink includes room for containing a heat condition material. The lamp house is used for configuring an light emitting device. The heat sink comprises a plurality of fins surround itself. The heat generated by the light emitting device can be dissipated into the air via the heat condition material and the fins.

### BACKGROUND OF THE INVENTION

1. Field of the Invention

The present invention generally relates to a heat sink, and more particularly to the heat sink configured on a lamp house.

2. Description of the Prior Art

Light emitting diode has the excellence of high brightness, low power consumption, long lifetime, and low temperature. Comparing to the drawbacks of the traditional lamp, it is a breakthrough. For examples, the light emitting diode can be used on a flashlight over 50 hours with 3 AAA batteries. Some excellent light emitting diodes can further used over 70 hours. Namely, the light emitting diodes have very excellent efficiency of power consumption.

For enhancing the brightness, the light emitting diodes are designed to have better illumination. Although the light emitting diodes are low power consumption, it still can not avoid generating a lot of heat within a limited space for better illumination. The heat will age or damage the other components in the surroundings. Therefore a better design for dissipating the heat.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

A heat sink device for configuring a lamp house is disclosed. The heat sink device includes a heat sink and a lamp house. The lamp house is telescoped into the heat sink. The heat sink includes room for containing a heat condition material. The lamp house is used for configuring a light emitting device. The heat sink comprises a plurality of fins surround itself. The heat generated by the light emitting device can be dissipated into the air via the heat condition material and the fins.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates the structure of the lamp house with a heat sink according to one embodiment of the present invention;

FIG. 2 and FIG. 3 are the side profiles of the lamp house with a heat sink; and

FIG. 4 is a diagram shows the lamp house with a heat sink.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

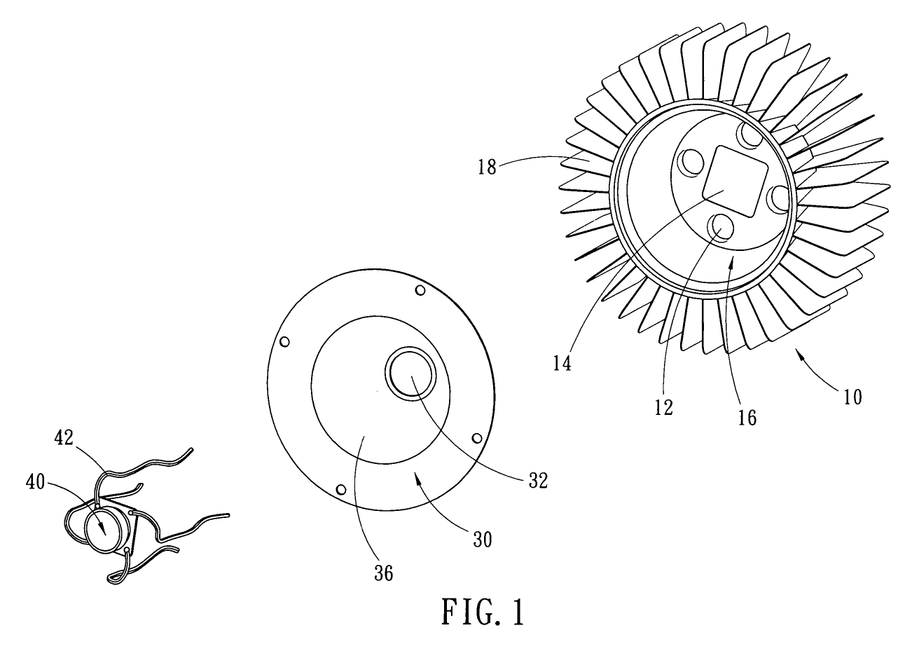

FIG. 1 illustrates the structure of the lamp house with a heat sink according to one embodiment of the present invention. The lamp house with a heat sink comprises a heat sink base 10 and a lamp house 30. The heat sink base 10 has a first cup structure 16 which is inward hollow. The bottom of the first cup structure 16 comprises at least a first hole 12. The heat sink base 10 can comprise a plurality of fins 18, wherein the first cup structure 16 is circularly surrounded by the fins 18. Furthermore, lamp house 30 has a second cup structure 36 which is inward hollow. The second cup structure 36 comprises at least a second hole 32 and is telescoped into said heat sink base 10.

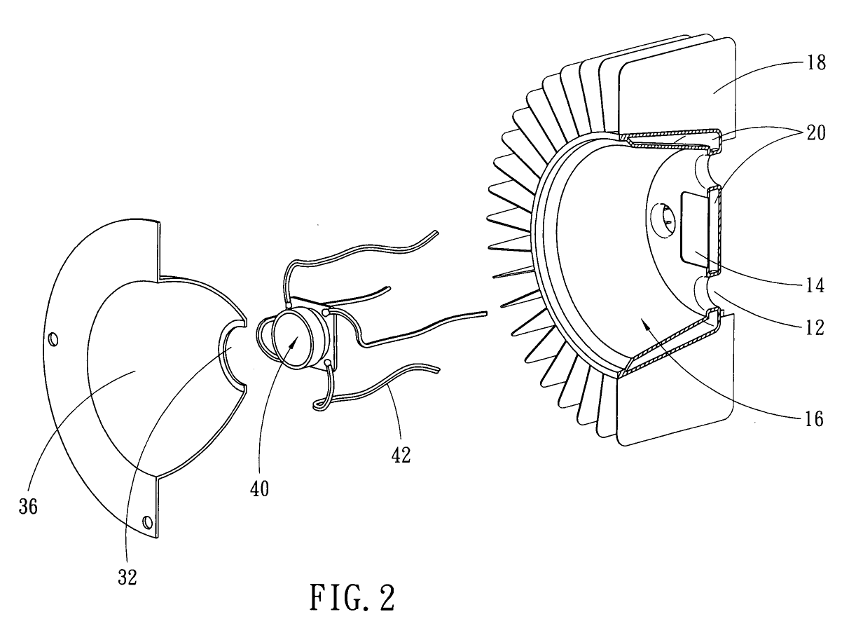

Referring to FIG. 2, heat sink 10 has closed space 20. The closed space 20 can be a ringlike space surrounded by a plurality of fins. The shape of the closed space 20 can also be like a cup. Besides, the closed space 20 circularly surrounds the first hole 12. The embodiment further comprises a heat conduction material (not shown in the figures) within the closed space 20. The heat conduction material can be injected into the closed space 20 through a hole. After injecting, the hole can sealed to form the closed space 20.

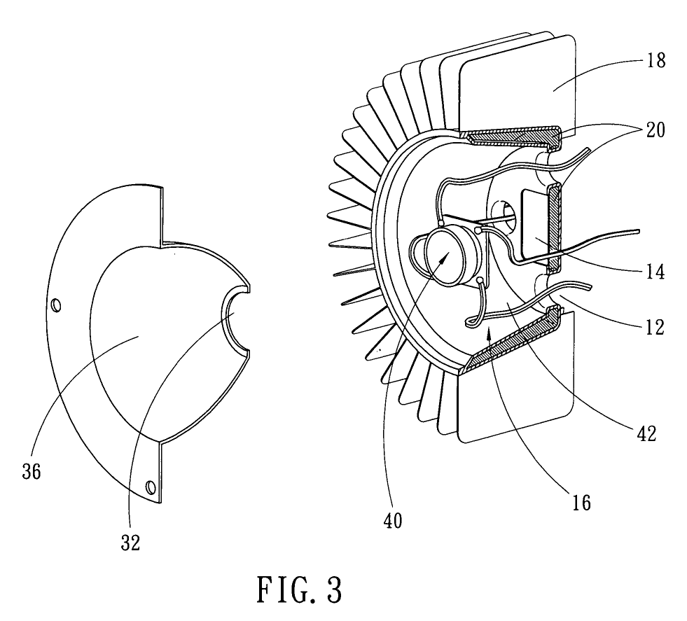

Referring to FIG. 3, the embodiment can further comprises a light emitting device 40 configured on said second hole 32. The light emitted device 40 comprises at least a wire, wherein each wire goes through one of the first holes 12 and one of the second holes 32. Moreover, the light emitting device 40 can further comprises the relative circuit components, i.e. the printed circuit board. Furthermore, the bottom of the first cup structure can further comprise a base which can be an inward hollow area for configuring with the relative circuit components of the light emitting device 40.

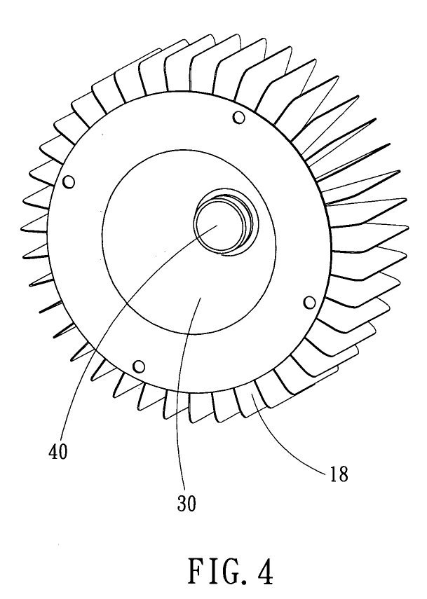

Accordingly, referring to FIG. 4, the light emitting device 40 inside the lamp house 30 can get the electric power or control signals outside the lamp house via the wires 42 when the heat sink base 10 and lamp house 30 are telescoped. Besides, the heat can be conducted to the fins via the heat conduction material, thereby the heat can be dissipated well.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A lamp house with a heat sink, comprising:
a heat sink base with a first cup structure which is inward hollow, wherein the bottom of said first cup structure comprises at least a first hole, wherein there is a closed space inside said head sink set; and
a lamp house with a second cup structure which is inward hollow, wherein said second cup structure comprises at least a second hole and is telescoped into said heat sink base.

2. A lamp house with a heat sink of claim 1, wherein said heat sink base comprises a plurality of fins.

3. A lamp house with a heat sink of claim 2, wherein said first cup structure is circularly surrounded by said fins.

4. A lamp house with a heat sink of claim 3, wherein said closed space is a ringlike space circularly surrounded by said fins.

5. A lamp house with a heat sink of claim 1, wherein the configuration of said closed space is like a cup and said closed space circularly surrounds said first hole.

6. A lamp house with a heat sink of claim 1, further comprising a heat conduction material within said closed space.

7. A lamp house with a heat sink of claim 1, further comprising a light emitting device configured on said second hole.

8. A lamp house with a heat sink of claim 7, wherein said light emitted device comprises at least a wire, wherein each wire goes through one of said first holes and one of said second holes.

9. A lamp house with a heat sink of claim 8, wherein the bottom of said first cup structure comprises an inward hollow area.
